(19) United States
(12) Patent Application Publication
(10) Pub. No.: US 2018/0300827 A1
(43) Pub. Date: Oct. 18, 2018

(54) Persuasive Citations System

(71) Applicant: Toby Unwin, Miami, FL (US)

(72) Inventor: Toby Unwin, Miami, FL (US)

(73) Assignee: Premonition LLC, Miami, FL (US)

(21) Appl. No.: 15/486,302

(22) Filed: Apr. 13, 2017

(51) Int. Cl. G06Q 50/18; G06T 11/20

(52) U.S. Cl. CPC G06Q 50/18; G06T 11/206

(57) ABSTRACT

The current invention is a system, method and program that can that can identify the precedents and statutes within legal documents. Based on records of “win rates” allows the system to produce a “win rate” for precedents and statutes, essentially measuring its persuasiveness. The system can filter these by case type, court, individual judge and keyword. The system provides this information in an easy to read and understand graphic display.

### CROSS-REFERENCES TO RELATED APPLICATIONS (IF ANY)

None

### BACKGROUND OF INVENTION

### Field of the Invention

The present invention is directed to a method of analyzing and quantifying a legal citation success rate, more particular with a graphical results page.

### Background

For centuries lawyers have used citations systems to get the right answer to the wrong question. They ask “Is this good law?”. They should be asking “Is this persuasive law?” i.e. will it be persuasive for my case type in front of my judge?

There is still room for improvement in the art.

### SUMMARY OF THE INVENTION

The current invention is an artificial intelligence system that can identify the precedents and statutes within legal documents. Analyzing records of “win rates” allows the system to produce a “win rate” for precedents and statutes, essentially measuring its persuasiveness. These can be filter by case type, court, individual judge and keyword.

The system provides this information in an easy to read and understand graphic display.

Given the significant value of these types of cases the monies involved can be substantial.

### BRIEF DESCRIPTION OF THE DRAWINGS

Without restricting the full scope of this invention, the preferred form of this invention is illustrated in the following drawings:

FIG. 1 is a block diagram showing a basic arrangement of a computer system that can run the current invention; and

FIG. 2 is a schematic block diagram of a conceptualized operation of the present invention

FIG. 3 is an example of the citations and percentage win rate;

FIG. 4 shows a graphic result of the win rates.

### BRIEF DESCRIPTION OF THE PREFERRED EMBODIMENTS

There are a number of significant design features and improvements incorporated within the invention.

The current invention is a system 1, method and program product that uses past case history from how persuasive citations were in various cases and before certain judges.

The system 1, uses an artificial intelligence system that can identify the precedents and statutes within legal documents. This is used to produce a “win rate” for precedents and statutes, essentially measuring its persuasiveness. These can be filter by case type, court, individual judge and keyword. It is litigation analysis. It provides this information in an easy to read and understand graphic display.

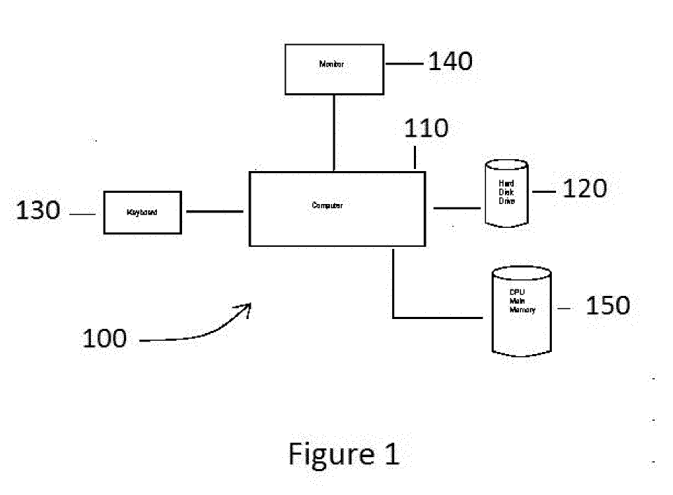

The system 1 can be set up to be run a on a computing device. FIG. 1 is a block diagram showing a computing device 100 on which the present invention can run comprising a CPU 110, Hard Disk Drive 120, Keyboard 130, Monitor 140, CPU Main Memory 150 and a portion of main memory where the program resides and executes. A printer can also be included. Any general purpose computer with an appropriate amount of storage space is suitable for this purpose. Computer Devices like this are well known in the art and is not pertinent to the invention.

The computer device 100 could be connected to other computer devices 100 through a communication interface such as the Internet, a wide area network (WAN), internetwork, telephone network or a private Value Added Network (VAN).

The storage and databases for the system may be implemented by a single data base structure at an appropriate site, or by a distributed data base structure that is distributed across an intra or an Internet network.

The files and file components discussed herein may be paper files, but in a preferred embodiment comprise data structures with electronic data. The setting up of the files and file structure is commonly known in the art and is not disclosed here. The system 1, data, files and processing code can reside in the non-transitory memory of the one or more computing devices.

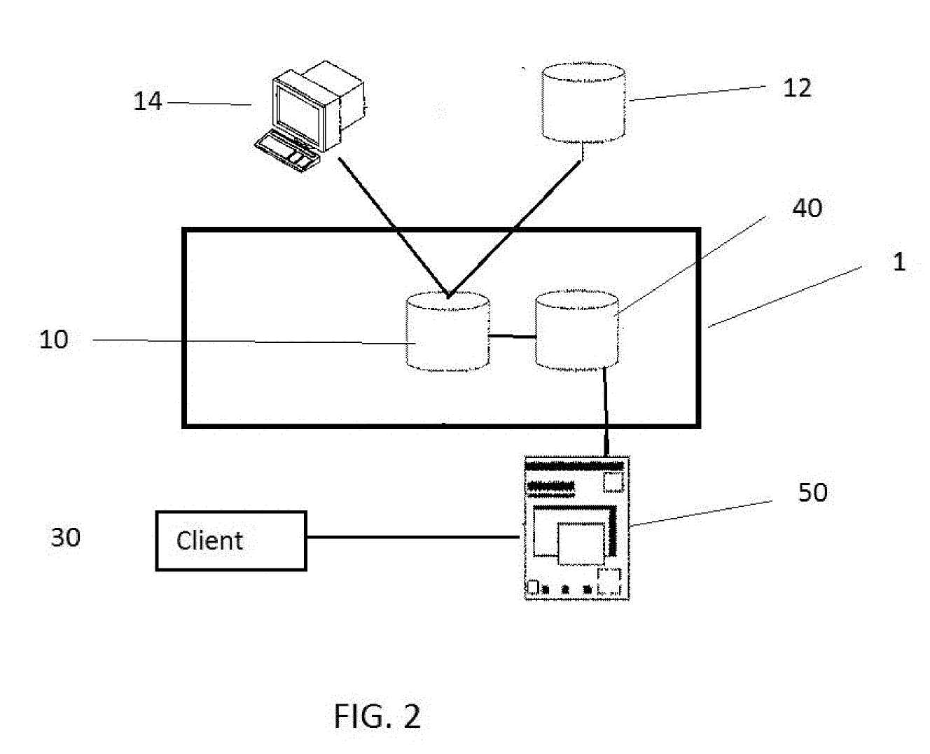

This system 1 is shown in FIG. 2, the System 1 will gather information 10 about court case results based on citations such as precedents and statutes. These can be from certain judges or fields or jurisdictions or all three. It can be limited to the fields of practice or jurisdictions or even down to actual before a particular judge.

The information 10 about the citations can be gathered from court databases 12 or keyed into the system 1 by a keyboard entry 14 or any other method of entry. The information 10 will have data on everything relevant available that can be used to analysis the litigation results. This data would include but not limited to the judge the case was heard, the type of case, the whether the case went to trail, the success of the attorney, the settlement received and whether the attorney represented the plaintiff or the defendant.

This data 40 can be specifically analyzed using a computer processing means for the client 30 depending on their needs or their specific case. The client 30 can be an individual, a small company, an attorney or even a large corporation.

The data 40 is loaded into electronic medium and is analyzed by the system 1 based on the desired criteria.

The system 1 will use the data 40 to produce an easy to read and understand results graph 50 as shown in FIG. 4.

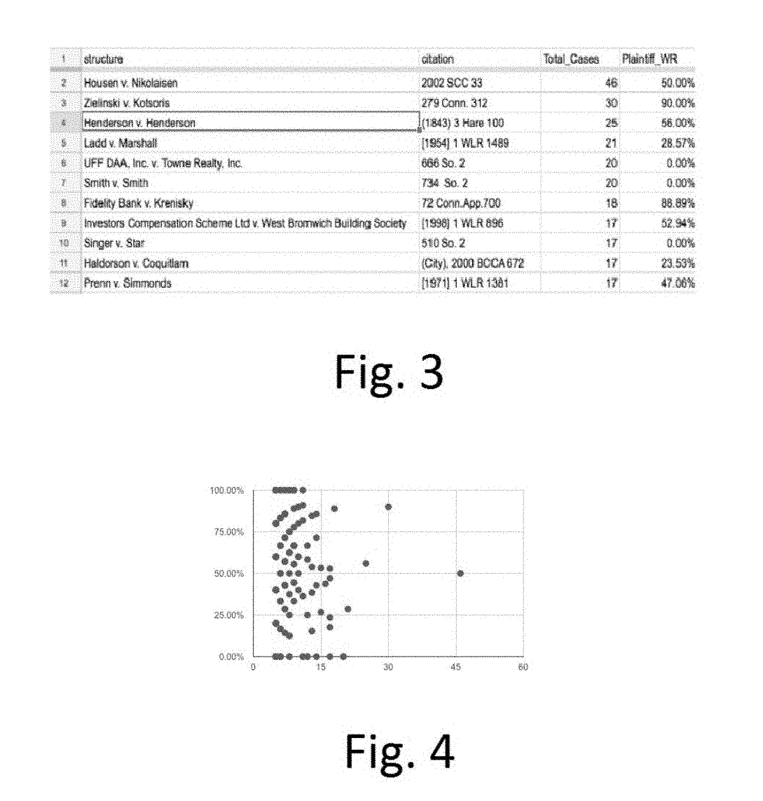

FIG. 3 shows the court cases and the citations used as well as the results based on using that citation. This information can be shown in a graph form such as shown in FIG. 4.

It should be appreciated that many other similar configurations are within the abilities of one skilled in the art and all of these configurations could be used with the method of the present invention. Furthermore, it should be recognized that the computer system and network disclosed herein can be programmed and configured by one skilled in the art in a variety of different manners to implement the method steps described further herein.

Advantages

The advantages of this to attorneys to know which citations to use for which type of lawsuit so that they use the right citations of law and precedent to use to win their case. Given the size of many law suits the potential income is significant.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A method comprising the steps: having a information about previous court cases, loading this information into a database stored on electric means, using this information to create data, using the data to create a graphical output about a citation's success rate.

2. The method as defined in claim 1, wherein said success rate is based on cases before a certain judge.

3. The method as defined in claim 1, where said success rate is based on cases before a certain court.

4. The method as defined in claim 1, said success rate is based on cases on a certain type of cases.

5. The method as defined in claim 1, where said graph displays the citation's win percentage.

6. A system comprising: information about court case results for a set period where the information is reviewed based on specific criteria and results are outputted in a graphic format where that criteria is the citation given in the court cases.

7. The system as defined in claim 6 where the graphical output displays a citation's success rate.

8. The system as defined in claim 7, wherein said success rate is based on cases before a certain judge.

9. The system as defined in claim 7, where said said success rate is based on cases before a certain court.

10. The system as defined in claim 7, said success rate is based on cases on a certain type of cases.

11. The system as defined in claim 7, where said graph displays the citation's win percentage.
